(19) United States
(12) Patent Application Publication
(10) Pub. No.: US 2026/0180904 A1
(43) Pub. Date: Jun. 25, 2026

(54) ETHERNET STORM CONTROL SYSTEMS AND METHODS

(71) Applicant: Schweitzer Engineering Laboratories, Inc., Pullman, WA (US)

(72) Inventors: Cory McGillivray Holt, Moscow, ID (US); Joseph F. Farley, Moscow, ID (US)

(73) Assignee: Schweitzer Engineering Laboratories, Inc., Pullman, WA (US)

(21) Appl. No.: 19/200,957

(22) Filed: May 7, 2025

Related U.S. Application Data
(60) Provisional application No. 63/737,955, filed on Dec. 23, 2024.

(51) Int. Cl. H04L 47/12; H04L 47/62; H04L 47/72

(52) U.S. Cl. CPC H04L 47/12; H04L 47/62; H04L 47/72

(57) ABSTRACT

A protective intelligent electronic device (IED), such as a protective relay, includes a processor to execute protection routines and/or data acquisition routines. The protective IED or an associated networking device may include, for example, a measurement module to monitor processor burden and control logic to detect Ethernet storms based on a dynamic burden function threshold. In response to storm detection, non-critical Ethernet traffic is throttled while critical protection functions are maintained. Auxiliary communication subsystems and/or critical protocols such as RSTP may continue to function during a storm mitigation mode. The systems and methods described herein leverage dynamic CPU burden assessments, traffic prioritization, and hysteresis logic to limit toggling between storm mitigation and normal operation modes.

### CROSS-REFERENCE TO RELATED APPLICATION

The application claims priority to U.S. Provisional Application No. 63/737,955, filed Dec. 23, 2024, titled “Ethernet Storm Control Systems and Methods,” which is incorporated by reference in its entirety for all purposes.

### TECHNICAL FIELD

This disclosure relates to computer and network hardware management. More specifically, this disclosure relates to monitoring, managing, and controlling Ethernet storm events.

### BRIEF DESCRIPTION OF THE DRAWINGS

The written disclosure herein describes illustrative embodiments and examples that are nonlimiting and non-exhaustive. This disclosure references some of these embodiments, as depicted in the figures described below.

FIG. 1 illustrates a protective intelligent electronic device with Ethernet storm mitigation functionality, according to one embodiment.

FIG. 2 illustrates a protective IED connected to a network device that detects and responds to Ethernet storms, according to one embodiment.

FIG. 3 illustrates a control logic module to implement an Ethernet queuing system based on the communication protocol, according to various embodiments.

FIG. 4 illustrates a flow chart of a method to mitigate Ethernet storms, according to one embodiment.

FIG. 5 illustrates a flow chart of a method to mitigate Ethernet storms with a staggered restoration of normal Ethernet traffic, according to one embodiment.

### DETAILED DESCRIPTION

In electrical power systems, protective intelligent electronic devices (IEDs) are used to ensure the reliability and safety of power distribution. Traditionally, these devices have been designed to execute protection routines that safeguard the system from faults and anomalies. However, as power systems have evolved, the complexity and volume of data traffic, particularly Ethernet traffic, have increased significantly.

Ethernet storms can be characterized as excessive network traffic that can overwhelm processors. Especially in the context of protective IEDs in electrical power systems, Ethernet storms may jeopardize critical protection functions. Conventional systems lack the capability to address Ethernet storms dynamically and/or fail to maintain essential protection operations. Previous approaches to managing processor burdens in protective IEDs and associated networking devices have primarily focused on enhancing the processing capabilities of the devices (e.g., by upgrading hardware components, such as processors and memory) to handle increased data loads. More robust hardware provides temporary relief at an increased cost but does not address the root cause of traffic-induced burdens. Additionally, existing solutions do not effectively prioritize critical protection functions during periods of excessive data traffic.

Another approach has been the implementation of traffic management protocols that aim to regulate data flow within the network. These protocols can help mitigate the effects of Ethernet storms by controlling the data transmission rate. However, they often require complex configurations and may not be responsive enough to dynamically adjust to sudden changes in traffic patterns. Furthermore, protocol-specific approaches typically focus on Ethernet traffic without any means to ensure the continuity of critical protection functions. The presently described systems and methods introduce a comprehensive approach to prioritize critical tasks, dynamically manage network traffic, and ensure uninterrupted system performance.

The presently described systems and methods enhance the ability to manage Ethernet storms while maintaining critical functionality in protective IEDs (including protective relays and associated networking devices). In various embodiments, a measurement module (also referred to herein as a burden assessment module) collects runtime metrics related to processor usage. The runtime metrics may include, for example, the time spent handling Ethernet traffic, executing protection routines, executing other routines, executing protection threads, executing data acquisition threads, and/or other processing activities. A control logic module (also referred to herein as a traffic management module) evaluates the measured data and compares it with a dynamically adjustable or user-defined burden function threshold to detect an Ethernet storm. This burden function threshold is defined by a burden percentage (e.g., CPU burden) and a burden duration (e.g., a time period for which the CPU burden exceeds a threshold).

Upon detecting an Ethernet storm, the control logic module initiates a storm mitigation mode. In the storm mitigation mode, non-critical Ethernet traffic is throttled, while specific network traffic, such as Rapid Spanning Tree Protocol (RSTP) packets, continues uninterrupted. RSTP packets are used to maintain the stability and integrity of the network during an Ethernet storm. RSTP is a protocol used to dynamically configure and maintain network topology, particularly in environments where links may fail or need to be reconfigured. If RSTP packets are blocked during an Ethernet storm, the network may interpret the absence of RSTP traffic as a loss of connectivity, triggering unnecessary reconfigurations or causing parts of the network to become isolated. For instance, a supervisor device may determine that the protective IED is offline even though it is still online to implement its protective actions via, for example, the auxiliary communication subsystems such as Mirrored Bits or other serial communication protocols.

By ensuring the continuity of RSTP communication, the system prevents cascading network issues, which could exacerbate the Ethernet storm by generating additional Ethernet traffic. Moreover, RSTP packets are lightweight and sent at predictable intervals, so they impose minimal additional burden on the processor even during high-stress Ethernet storms or protective action conditions.

In some embodiments, the system may employ multiple packet queues to categorize Ethernet traffic. For example, RSTP traffic may be exclusively assigned to the first queue. Other traffic may be assigned to other queues. For instance, GOOSE traffic may be assigned to a second queue, a third queue may be left unused for user-defined protocols, and a fourth queue may be used for TCP/IP traffic. Any number of queues may be used to define and categorize the network traffic according to any number of protocols. The pre-categorization of network traffic may be used to quickly transition to storm mitigation mode by processing only the traffic from specific queues (e.g., only from the first queue to prioritize RSTP network traffic). In various embodiments, the RSTP traffic may be prioritized during storm conditions to reduce the processing time and enhance the responsiveness of the network traffic most salient to protective operations.

In some embodiments, a device may include an auxiliary communications subsystem. The processor may continue to receive and process communications from the auxiliary communications subsystem to ensure critical protection functions remain operational even during Ethernet storms. The auxiliary communications subsystem provides communication via non-Ethernet protocols, such as serial communication channels and/or Mirrored Bits, which may be used to provide uninterrupted protection functionality.

In the various embodiments, the control logic module resumes normal Ethernet traffic flow once the processor burden stabilizes below the threshold for a predefined duration. In some embodiments, a hysteresis logic module ensures a smooth transition back to normal operation and/or optimizes system performance. For example, the hysteresis logic module may limit or prevent excessive toggling between storm mitigation and normal operation modes (e.g., only allow toggling after sustained CPU utilization has fallen below a utilization threshold for a defined duration. For example, a toggling time threshold value may be used, such as 500 ms, 1 second, 10 seconds, etc. The system may be prevented from toggling back to the normal operation mode until the system has been in the storm mitigation mode for at least the toggling time threshold value. In some embodiments, the hysteresis logic module may implement a delay mechanism to stagger the restoration of normal Ethernet traffic to prevent abrupt CPU burden spikes.

In various embodiments, the system further incorporates the capability to generate alarm signals when the burden function threshold is exceeded. Stored information and historical data may be used for diagnostic purposes and/or allow for proactive maintenance.

In various embodiments, a protective IED or associated networking device implements a protection method that continuously monitors processor utilization by measuring the time spent on protection routines, data acquisition tasks, and Ethernet traffic handling. The measured utilization is compared against a predefined utilization threshold percentage to detect Ethernet storms. Once an Ethernet storm is identified, the system throttles non-essential Ethernet traffic and/or prioritizes network traffic associated with protection threads and subroutines. The system may also maintain essential protocols like RSTP and preserve critical protection functions through auxiliary communication channels. In embodiments using disparate packet queue approaches described herein, the system may manage packet queue processing during storm mitigation by focusing only on or at least prioritizing the queue that contains RSTP traffic.

The presently described systems and methods ensure rapid access to critical network traffic during ethernet storm conditions. The dynamically adjustable burden function threshold and customizable traffic queue configurations allow for tailored responses to varying network conditions. In some embodiments, critical protection functions are preserved through auxiliary communication subsystems, such as Mirrored Bits, which ensures reliability even when Ethernet traffic is heavily throttled or unavailable.

The term intelligent electronic device “IED” may refer to any microprocessor-based device that monitors, controls, automates, and/or protects monitored equipment within a system. Such devices may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, motor drives, controllers for a wide-area monitoring system (WAMS), remedial action scheme (RAS) or special protection scheme (SPS) controllers, and the like. IEDs may be connected to a network, and communication on the network may be facilitated by networking devices including, but not limited to, multiplexers, routers, hubs, gateways, firewalls, and switches. Furthermore, networking and communication devices may be incorporated into an IED or be in communication with an IED.

The embodiments of the disclosure can be understood by reference to the drawings, wherein like parts are designated by like numerals throughout. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order or even sequentially, nor do the steps need to be executed only once unless otherwise specified.

Several aspects of the embodiments described may be implemented as software modules, hardware components, and/or combinations thereof. As used herein, a software module or component may include any type of computer instruction or computer executable code located within a memory device and/or transmitted as electronic signals over a system bus or wired or wireless network. A software module or component may, for instance, comprise one or more physical or logical blocks of computer instructions. Software modules or components may comprise disparate instructions stored in different locations of a memory device, which together implement the described functionality of the module. Indeed, a module or component may comprise a single instruction or many instructions and may be distributed over several different code segments, among different programs, and across several memory devices. Some embodiments may be practiced in a distributed computing environment. For example, a module may include non-transitory computer-readable instructions implemented or executed by a processor to effectuate specific operations or functions. In some instances, the term “module” may be used interchangeably with the term “subsystem” and may refer to an operational device or component implemented with any combination of hardware, software, and/or firmware.

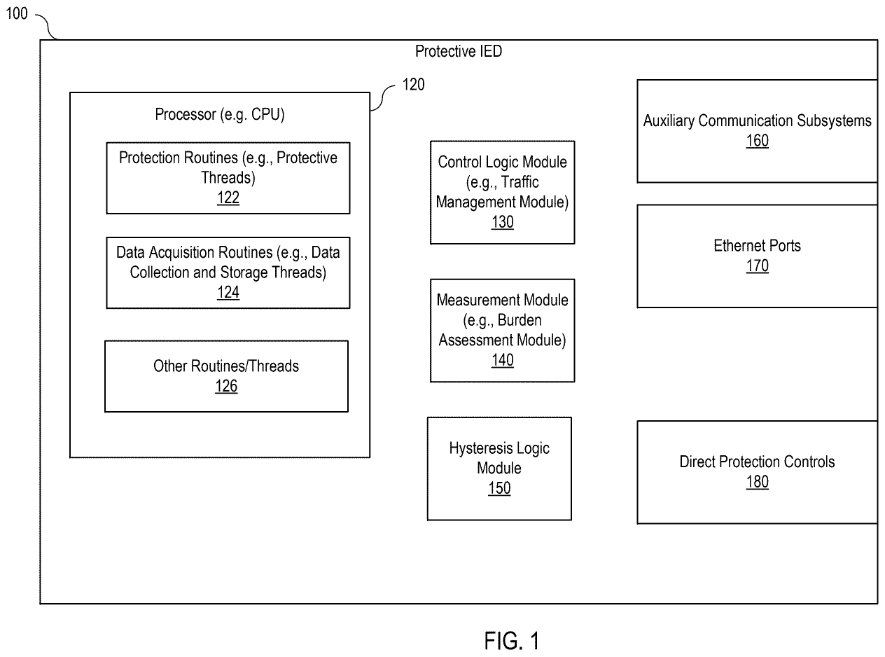

FIG. 1 illustrates a protective intelligent electronic device (IED) 100, such as a relay or other protective device. The protective IED 100, as described herein, is configured to manage Ethernet storms while ensuring the continuity of critical protection functions. The protective IED 100 includes a processor 120 to execute multiple routines or threads. For example, the processor 120 handles protection routines 122 relevant to real-time protective actions such as opening breakers during electrical faults. The processor 120 also handles data acquisition routines 124 to collect and process operational data from the system. Additionally, the processor 120 may also handle other routines or threads 126, such as background tasks or auxiliary functions that support the overall operation of the protective IED.

A measurement module 140 is connected to the processor 120 and continuously or periodically monitors a burden on the processor 120 (e.g., a processor burden) by measuring runtime metrics. The measured runtime metrics may include, for example, the time and/or processor resources used for Ethernet traffic handling, the execution of protection functions, and/or any other routines or threads. The measurement module 140 provides data to the control logic module 130. The control logic module 130 operates to detect when the processor burden exceeds a predefined burden function threshold. The burden function threshold may be a function of both a burden percentage and a burden duration. The control logic module 130 detects the presence of an Ethernet storm based on the measured processor burden exceeding the burden function threshold.

For example, the burden function threshold may be exceeded when the burden percentage of clock cycles on the CPU exceeds various values for various durations of time. By way of example, the burden function threshold may be exceeded when (i) the burden percentage exceeds 65% for more than 5 seconds, (ii) the burden percentage exceeds 75% for more than 1 second, and (iii) the burden percentage exceeds 90% for more than 0.1 seconds. The burden function threshold may be defined according to any number of burden percentages and burden durations. In some embodiments, a burden percentage or set of burden percentages of a burden function threshold may be associated with a null value for the burden duration, such that the control logic module 130 immediately detects an ethernet storm.

For example, the measurement module 140 may monitor and collect the amount of time that the processor 120 is being spent in Ethernet processing ISRs (interrupt service routines). For example, the measurement module 140 may monitor and collect the amount of time spent on the protection ISRs of long queued serial peripheral interface (QSPI). The measurement module 140 may also monitor and collect the amount of time spent on the data acquisition (DAQ) ISR (short QSPI). The measurement module 140 may also collect the amount of time spent in Ethernet-receive ISRs and direct memory access (DMA) ISRs.

The control logic module 130 evaluates the collected data to determine if an Ethernet storm is present. For example, the control logic module 130 may detect an Ethernet storm when the total Ethernet receive ISR time, the DMA ISR time, and the total QSPI ISR time amounts to more than 75% of the total processor bandwidth in each quarter cycle. Thus, the control logic module 130 may implement an Ethernet storm detection algorithm according to a variation of the following equation:

$$Bandwidth = \frac{( {T}_{LongQSPI} + {T}_{ShortQPSI} + {T}_{EthRxISR} + {T}_{DMAISR} )}{{T}_{QCycle}} * 100 \qquad Equation 1$$

In Equation 1, T_{LongQSPI} represents the time spent in the Protection ISR during a quarter cycle, T_{ShortQSPI} represents the total time spent in the DAQ/Sample ISR during a quarter cycle, T_{EthRxISR} represents the total time spent in the Ethernet Rx ISR during a quarter cycle, and T_{DMAISR} represents the total time spent in the DMA Complete ISR during a quarter cycle. The control logic module 130 may detect an Ethernet storm when the calculated Bandwidth value exceeds a defined percentage (e.g., 75%). Thus, the burden function threshold may be defined as a function of the burden percentage and a burden duration, where the burden percentage is calculated according to Equation 1, and the burden duration is a function of the cycle time or set time, such as 10 ms, 50 ms, 100 ms, etc.

In response to the detection of an Ethernet storm, the control logic module 130 takes action to throttle non-critical Ethernet traffic while ensuring that critical protection functions remain uninterrupted. As illustrated, the protective IED includes Ethernet ports 170 for incoming and outgoing network traffic. The protective IED may, in some embodiments, include one or more direct protection controls 180 to provide immediate access to execute critical protective actions (e.g., open a breaker). In other embodiments, the protective decisions made by the protective IED 100 are communicated via the auxiliary communication subsystems 160 and/or Ethernet ports 170 to external devices that implement the protective actions.

The auxiliary communication subsystems 160 provide alternate communication channels that preserve operational communication during the throttling phase. The auxiliary communication subsystems 160 support non-Ethernet protocols, such as serial communication or Mirrored Bits, that allow the protective relay to continue to perform essential protective functions despite the Ethernet storm. In some embodiments, the protective IED 100 may not include any auxiliary communication subsystems 160. In such embodiments, the protective IED 100 may prioritize and/or only allow Ethernet communications with specific devices on the network (e.g., based on MAC or IP addresses) that are relevant to the protective functions. Additionally or alternatively, the protective IED 100 may prioritize and/or only allow Ethernet communications in specific protocols relevant to the protective functions and/or otherwise identified as being relevant to a protective function (e.g., in a packet header).

In various embodiments, the protective IED 100 includes a hysteresis logic module 150 that prevents excessive toggling between storm mitigation and normal operation modes. The hysteresis logic module 150 ensures that the control logic module 130 transitions smoothly back to normal operations once the processor burden stabilizes below the burden function threshold for a defined duration. In some embodiments, the functionality of the hysteresis logic module 150 may be integrated into the control logic module 130.

The measurement module 140, the control logic module 130, and the hysteresis logic module 150 allow the protective IED 100 to manage network traffic effectively, respond dynamically to Ethernet storms, and maintain the reliability of critical protection routines via ethernet ports 170 and auxiliary communication subsystems 160 under challenging conditions.

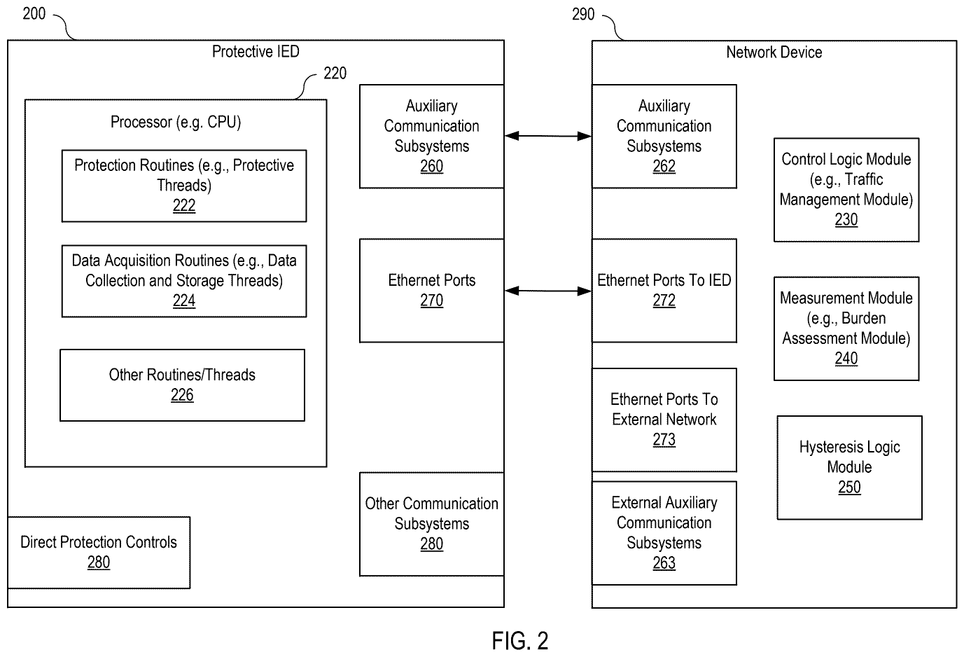

FIG. 2 illustrates a protective IED 200 connected to a network device 290. According to various embodiments, implementing the control logic module 230, the measurement module 240, and the hysteresis logic module 250 within the network device 290 allows for modular deployment of the Ethernet storm detection and mitigation system. In some embodiments, a single network device 290 may provide Ethernet storm detection and mitigation for more than one connected protective IED 200. In such embodiments, each protective IED 200 connected to the network device 290 can focus primarily on executing critical protection routines and data acquisition tasks, while network traffic management, including Ethernet Storm detection and mitigation, is handled by the network device 290.

In the illustrated embodiment, the protective IED 200 operates similarly to the protective IED 100 described in FIG. 1, with a processor 220 executing various routines or threads. For example, the processor 220 may handle protection routines 222 relating to real-time protective actions within the power system. The processor 220 may also execute data acquisition routines 224 to collect and process operational data from the system and/or other routines or threads 226.

The network device 290 includes a control logic module 230, a measurement module 240, and a hysteresis logic module 250, which collectively manage Ethernet traffic and detect and mitigate Ethernet storms, as described in the context of control logic module 130, measurement module 140, and hysteresis logic module 150 of FIG. 1. For example, the measurement module 240 receives information from the protective IED 200 that it uses to monitor the processor burden (e.g., based on various runtime metrics, such as the time and processor resources consumed by Ethernet traffic handling and protection functions. Since measurement module 240 is not integrated directly into the protective IED 200, the protective IED 200 must communicate these metrics to the network device 290 via the respective auxiliary communication subsystems 260 and 262, the respective ethernet ports 270 and 272, and/or via an alternative communication channel (e.g., a dedicated communication channel).

Regardless of the specific implementation, the measurement module 240 periodically or continuously collects the usage metrics for evaluation by the control logic module 230. The control logic module 230 operates according to any of the various embodiments described in the context of the control logic module 130 of FIG. 1 to detect Ethernet storms.

Accordingly, the measurement module 240 may track metrics such as the time spent in Ethernet receive ISRs, DMA ISRs, and critical processing routines such as the Protection ISR (long QSPI) and DAQ ISR (short QSPI). The control logic module 230 uses these values to compute the processor burden as a percentage of the total available bandwidth over a time period, such as during a quarter cycle using, for example, a formula similar to that of Equation 1.

As previously described, the control logic module 230 integrated within the network device 290 throttles non-essential Ethernet traffic to preserve critical network functionality during a detected Ethernet storm. The external ethernet ports 273 and the external auxiliary communication subsystems 263 on the network device 290 facilitate the incoming and outgoing network traffic. The ethernet ports 272 and the auxiliary communication subsystems 262 on the network device 290 facilitate communication with the protective IED 200.

The control logic module 230 prioritizes essential communications, such as Rapid Spanning Tree Protocol (RSTP) traffic and, in some embodiments, GOOSE traffic, while deprioritizing or blocking non-critical Ethernet traffic. The network device 290 may leverage packet queuing, as described above, to ensure rapid access to critical data during an Ethernet storm.

Even during an Ethernet storm, communications from the external auxiliary communication subsystems 263 may be passed through the auxiliary communication subsystems 262 of the network device 290 to the auxiliary communication subsystems 260 of the protective IED 200. The various auxiliary communication subsystems may support non-Ethernet protocols, such as serial communication or Mirrored Bits, enabling critical protection functions to continue despite the Ethernet storm. The network device 290 may further refine Ethernet traffic prioritization by permitting communication with specific MAC or IP addresses and/or by restricting communication to specific protocols relevant to protective operations.

In various embodiments, the hysteresis logic module 250 prevents excessive or rapid toggling between storm mitigation and normal operational modes and may facilitate a smooth transition back to normal operations by staggering the increased Ethernet load over time. In various embodiments, the protective IED 200 may include other communications subsystems 280 (Ethernet, serial, SCADA, GOOSE, etc.) that are not routed through the network device 290. Communication via the other communication subsystems 280 is not affected when the network device operates in storm mitigation mode.

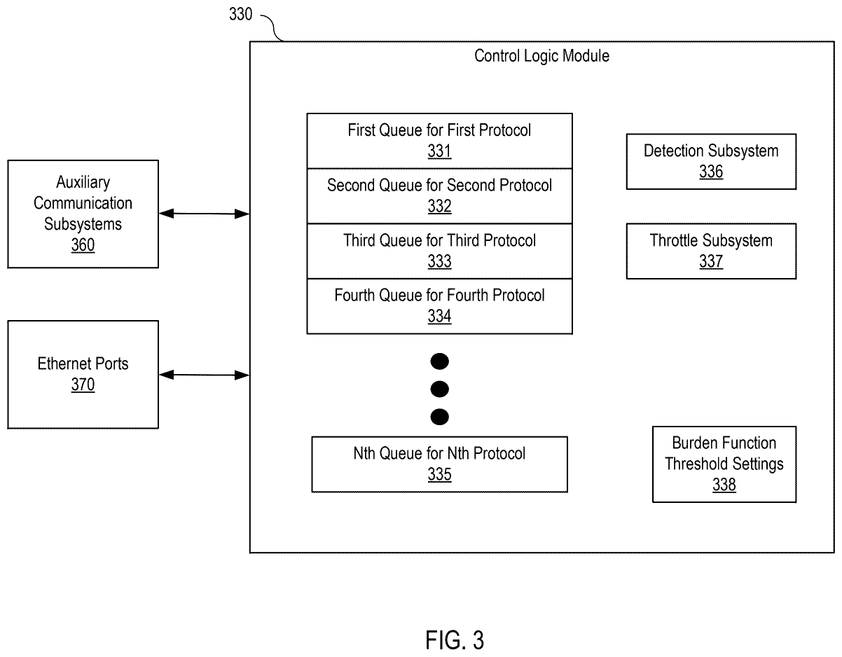

FIG. 3 illustrates a control logic module 330 implementing the queuing system described herein. The control logic module 330 leverages the queuing system, according to various embodiments, to manage Ethernet traffic from Ethernet ports 370 in the context of a protective IED or a network device connected to a protective IED. As illustrated, the control logic module 330 includes a series of packet queues, including a first queue for a first protocol 331, a second queue for a second protocol 332, a third queue for a third protocol 333, a fourth queue for a fourth protocol 334, and so on until the Nth queue for the Nth protocol 335. Each queue 331-335 may be designated for one or more specific types of communication protocols. The queuing architecture enhances the responsiveness and efficiency of the system, particularly during Ethernet storms, by sorting and prioritizing network traffic into discrete categories. Communication via the Auxiliary communication subsystems 360 with the protective IED is uninterrupted during an Ethernet storm.

In various embodiments, the first queue 331 is reserved exclusively for RSTP traffic. This fixed assignment ensures that RSTP traffic is always processed with relatively high priority, regardless of other configurations or network conditions, including during a detected Ethernet storm. As previously described, RSTP packets are used to maintain the stability of the network topology. By isolating RSTP traffic to the first queue 331, the system can quickly access and process these packets during Ethernet storm conditions without having to search through all the packets or other queues 332-335. In various other embodiments, the first queue 331 may be configured to include user-specified traffic such as GOOSE traffic.

The second queue 332 may be, for example, configured to handle GOOSE traffic, a protocol commonly used for critical messaging in electrical power systems. Depending on the state of the processor, the control logic module 330 may allow GOOSE traffic from the second queue to be processed during an Ethernet storm. The third queue 333 may be unused in the default configuration and reserved for future expansion or user-specific customization. The fourth queue 334 may be allocated for general TCP/IP traffic. As this traffic may generally be associated with a range of non-critical communications, the control logic module 330 may restrict or prevent network traffic in this queue from being processed during a detected Ethernet storm. Any number of additional queues, represented by the Nth queue 335, may be configured for other protocols or traffic types depending on the system's specific requirements and/or user customization.

According to various embodiments, the queuing architecture is dynamically configurable to adjust the priority and processing of network traffic during normal operation and during an Ethernet Storm control mode (e.g., control of priority based on different Ethernet traffic types, protocols, and/or via VLAN tagging). For example, a user may reprioritize traffic so that a specific protocol is routed to a different queue.

As illustrated, the control logic module 330 also includes a detection subsystem 336, a throttle subsystem 337, and burden function threshold settings 338. The burden function threshold settings 338 allow for a predefined or user-defined threshold used to trigger an Ethernet storm condition, as described herein. According to the various embodiments, the burden function threshold settings 338 may be set as a function of the processor burden and duration of the processor burden in terms of or as a function of, for example, the Ethernet receive ISRs, the DMA ISRs, the Protection ISRs, and the DAQ ISRs.

According to various embodiments, the detection subsystem 336 operates to detect or otherwise determine that a measured processor burden exceeds the burden function threshold. As described above, the burden function threshold may be predefined or customized as a function of a burden percentage and a burden duration indicative of an Ethernet storm. The throttle subsystem 337 operates to throttle (e.g., reduce, restrict, selectively control, prevent) non-critical Ethernet traffic in response to an indicated Ethernet storm.

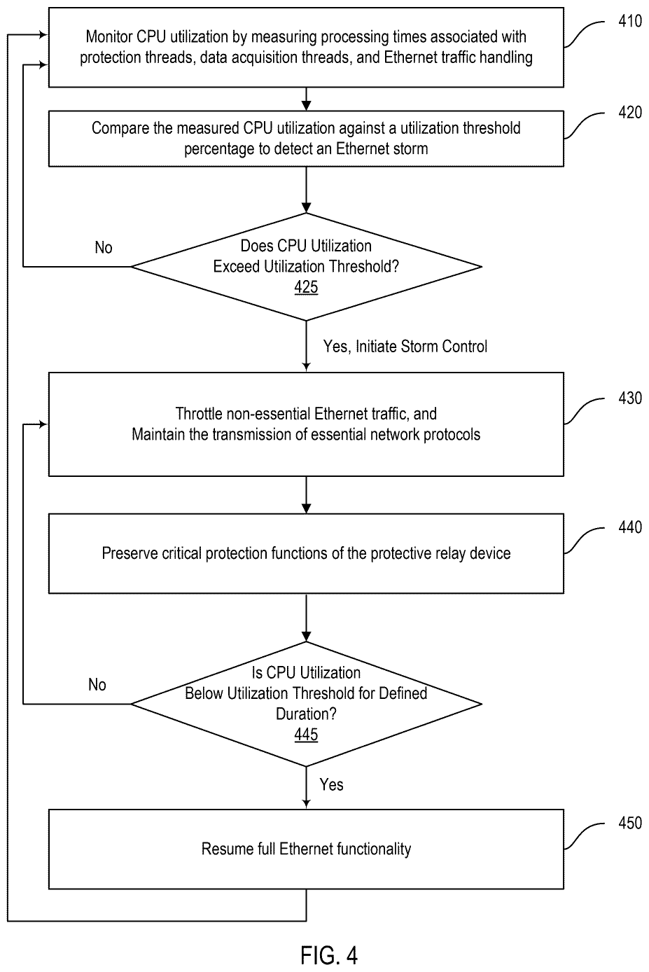

FIG. 4 illustrates a flow chart of a method to mitigate Ethernet storms. The method may be implemented by a protective IED or a network device to detect and respond to Ethernet storms while maintaining critical protective functions. As illustrated, the process begins with the monitoring of CPU utilization, at 410. The system measures processing times associated with protection routines, data acquisition routines, and Ethernet traffic handling. These measurements provide real-time data on the processor burden, allowing the system to evaluate its current operational load. The measured CPU utilization is compared, at 420, against a predefined utilization threshold percentage (e.g., a burden function threshold) to detect the presence of an Ethernet storm.

If the CPU utilization does not exceeds the utilization threshold, at 425, the process continues with the monitoring, at 410, and comparing, at 420. However, if the CPU utilization exceeds the utilization threshold, at 425, the system initiates storm mitigation measures, at 430. During storm mitigation, the system throttles, at 430, non-essential Ethernet traffic to reduce the processor burden while maintaining the transmission of essential network protocols, such as RSTP traffic. This prioritization ensures that critical protection functions and network integrity are preserved despite the adverse conditions caused by the Ethernet storm. The system also preserves, at 440, critical protection functions through auxiliary communication subsystems (e.g., Mirrored Bits or other serial communications) and/or by limiting Ethernet communications to specific high-priority devices and/or protocols associated with the protective functions of the protective IED

The system periodically evaluates the CPU utilization to see if it has fallen below the utilization threshold for a defined duration, at 445. If not, the system continues to operate in Ethernet storm mitigation mode by throttling non-essential Ethernet traffic, at 430, and preserving critical protective functions, at 440. However, if the CPU utilization has fallen below the utilization threshold for the defined duration, at 445, the system transitions out of storm mitigation mode and resumes full Ethernet functionality, at 450.

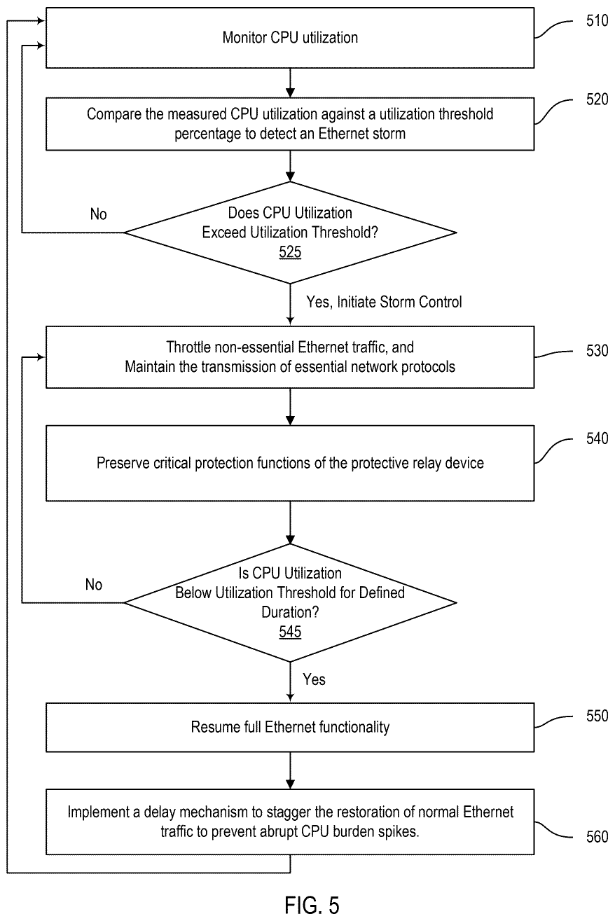

FIG. 5 illustrates a flow chart of a method to mitigate Ethernet storms with a staggered restoration of normal Ethernet traffic after the Ethernet storm has passed. Again, the method may be implemented by a protective IED or a network device. As illustrated, the process begins with the monitoring of CPU utilization, at 510. The measured CPU utilization is compared, at 520, against a predefined utilization threshold percentage (e.g., a burden function threshold) to detect the presence of an Ethernet storm. If the CPU utilization does not exceeds the utilization threshold, at 525, the process restarts or continues with the monitoring, at 510, and comparing, at 520.

If the CPU utilization exceeds the utilization threshold, at 525, the system initiates storm mitigation measures by throttling, at 530, non-essential Ethernet traffic. The system may maintain the transmission of one or more network protocols, such as RSTP traffic and/or GOOSE traffic. The system also preserves, at 540, critical protection functions through auxiliary communication subsystems (e.g., Mirrored Bits or other serial communications) and/or by limiting Ethernet communications to specific high-priority devices and/or protocols associated with the protective functions of the protective IED

The system maintains operation in the Ethernet storm mitigation mode for as long as the CPU utilization remains above the utilization threshold, at 545. In some embodiments, the system maintains operation in the Ethernet storm mitigation until the CPU utilization is below a different utilization threshold value than is used to enter the Ethernet storm mitigation mode. Once the CPU utilization has fallen below the utilization threshold (which may be different than the utilization threshold value used at 525, for a defined duration, at 545, the system transitions out of storm mitigation mode and resumes full Ethernet functionality, at 550.

The system's transition from storm mitigation mode to normal operation mode may be managed by hysteresis logic to prevent excessive toggling between storm and normal modes, ensuring smooth and stable operation. In the illustrated embodiment, the system may also implement, at 560, a delay mechanism to stagger the restoration of normal Ethernet traffic. The staggered or delayed introduction of normal Ethernet traffic may prevent or reduce abrupt spikes in processor burden during recovery.

It is appreciated that two or more of the systems, subsystems, components, modules, etc., that are described herein may be combined as a single system, subsystem, module, or component. Moreover, many of the systems, subsystems, components, and modules may be duplicated or further divided into discrete systems, subsystems, components, or modules to perform subtasks of those described herein. Any of the embodiments described herein may be combined with any combination of other embodiments described herein.

The components of some of the disclosed embodiments are described and illustrated in the figures herein. Many portions thereof could be arranged and designed in a wide variety of different configurations. Furthermore, the features, structures, and operations associated with one embodiment may be applied to or combined with the features, structures, or operations described in conjunction with another embodiment. In many instances, well-known structures, materials, or operations are not shown or described in detail to avoid obscuring aspects of this disclosure. Many of the illustrations are provided in a block diagram format to illustrate a general configuration and may not be drawn to scale. The right to add any described embodiment or feature to any one of the figures and/or as a new figure is explicitly reserved.

This disclosure has been made with reference to various examples and embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure, along with every permutation of the claims filed herewith. non-provisional application

What is claimed:

1. A protective intelligent electronic device (IED) for an electrical power system, comprising:
a processor configured to execute a protection routine and a data acquisition routine in an electrical power system;
a measurement module to measure a processor burden on the processor by collecting runtime metrics associated with Ethernet traffic and protection functions;
a control logic module to:
detect that the measured processor burden exceeds a burden function threshold, where the burden function threshold is a function of a burden percentage and a burden duration to indicate a presence of an Ethernet storm,
throttle non-critical Ethernet traffic in response to the indicated Ethernet storm, and
maintain critical protection functions despite the indicated Ethernet storm; and
an auxiliary communications subsystem to preserve operational communication via non-Ethernet protocols.

2. The protective IED of claim 1, wherein the control logic module is further configured to maintain a flow of specific network traffic.

3. The protective IED of claim 2, wherein the specific network traffic includes Rapid Spanning Tree Protocol (RSTP) traffic.

4. The protective IED of claim 1, wherein the control logic module is further configured to assign Ethernet traffic to a plurality of packet queues, wherein each queue is designated for a specific type of Ethernet traffic, and a first queue is reserved for Rapid Spanning Tree Protocol (RSTP) traffic.

5. The protective IED of claim 4, wherein the plurality of packet queues is dynamically configurable to allow user-defined prioritization of Ethernet traffic.

6. The protective IED of claim 4, wherein a second queue is reserved for GOOSE traffic, and a third queue is reserved for TCP/IP traffic, and wherein the control logic limits network traffic to that of the first queue in response to the indicated Ethernet storm.

7. The protective IED of claim 4, wherein the control logic is configured to process Ethernet traffic from only the first queue during storm mitigation mode.

8. The protective IED of claim 1, wherein the control logic module is further configured to resume normal Ethernet traffic flow in response to a reduction in the measured processor burden for a sustained resume threshold time.

9. The protective IED of claim 1, wherein the auxiliary communications subsystem comprises a communication channel for communication over an alternate non-Ethernet communication protocol.

10. The protective IED of claim 1, wherein the burden function threshold is dynamically adjustable based on preconfigured user settings.

11. The protective IED of claim 1, wherein the processor is further configured to generate an alarm signal in response to the burden function threshold being exceeded.

12. A network device with integrated Ethernet storm mitigation, comprising:
a communication module in communication with a protective intelligent electronic device (IED) in an electrical power system, the protective IED including a central processing unit (CPU) configured to execute protection processing threads for protection tasks and handle Ethernet traffic;
a burden assessment module to calculate a CPU usage metric by aggregating time spent on the protection processing threads and the handling of Ethernet traffic;
a traffic management module to:
implement a storm mitigation mode by dynamically restricting non-essential Ethernet traffic sent to the protective IED in response to the calculated CPU usage metric exceeding a burden function threshold, where the burden function threshold is a function of a burden percentage and a burden duration indicative of an Ethernet storm, and
resume a normal network traffic operation mode in response to the calculated CPU usage metric being below the burden function threshold; and
a configurable hysteresis logic module to limit toggling by the traffic management module between the storm mitigation mode and the normal network traffic operation mode based on a toggling time threshold value.

13. The network device of claim 12, wherein the traffic management module is configured to selectively prioritize network traffic sent to the protective IED based on a source address associated with the network traffic.

14. The network device of claim 12, wherein the traffic management module is configured to selectively prioritize network traffic sent to the protective IED based on a communication protocol of the network traffic.

15. The network device of claim 12, wherein the traffic management module is further configured to selectively prioritize network traffic sent to the protective IED during periods of high CPU usage.

16. The network device of claim 12, wherein the traffic management module is further configured to implement packet filtering based on Ethernet packet size during storm mitigation mode.

17. The network device of claim 12, wherein the configurable hysteresis logic module dynamically adjusts the toggling time threshold based on a network traffic profile.

18. A method to mitigate Ethernet Storms in a protective relay device, comprising:
monitoring CPU utilization by measuring processing times associated with protection threads, data acquisition threads, and Ethernet traffic handling;
comparing the measured CPU utilization against a utilization threshold percentage to detect an Ethernet storm;
initiating an Ethernet storm control mode by:
throttling non-essential Ethernet traffic, and
maintaining transmission of essential network protocols, including at least Rapid Spanning Tree Protocol (RSTP) Ethernet traffic;
preserving critical protection functions of the protective relay device during the Ethernet storm; and
restoring full Ethernet functionality in response to sustained CPU utilization falling below the utilization threshold for a defined duration.

19. The method of claim 18, wherein preserving the critical protection functions of the protective relay device during the Ethernet storm comprises allowing communication via at least one alternate communication channel.

20. The method of claim 19, wherein at least one alternate communication channel comprises a Mirrored Bits communication protocol.

21. The method of claim 19, wherein at least one alternate communication channel comprises a serial communication channel separate from Ethernet.

22. The method of claim 18, wherein initiating the storm control mode further includes blocking traffic from a specific source MAC address associated with the Ethernet storm.

23. The method of claim 18, further comprising:
implementing a delay mechanism to stagger restoration of normal Ethernet traffic to prevent abrupt CPU burden spikes.
